(19) United States
(12) Patent Application Publication
(10) Pub. No.: US 2014/0244274 A1
(43) Pub. Date: Aug. 28, 2014

(54) ENCODING DEVICE AND ENCODING METHOD

(71) Applicant: PANASONIC CORPORATION, Osaka (JP)

(72) Inventors: Tomofumi Yamanashi, Kanagawa (JP); Masahiro Oshikiri, Kanagawa (JP)

(73) Assignee: PANASONIC CORPORATION, Osaka (JP)

(21) Appl. No.: 14/348,987

(22) PCT Filed: Oct. 5, 2012
(86) PCT No.: PCT/JP2012/006423

§ 371 Date: Apr. 1, 2014

(30) Foreign Application Priority Data
Oct. 19, 2011 (JP) 2011-229616

(51) Int. Cl. G10L 19/02

(52) U.S. Cl. CPC G10L 19/02
USPC 704/500

(57) ABSTRACT

An encoding device is disclosed in which frequency domain converters (701, 702) acquire a conversion coefficient in which a frequency band is divided between low end and high end, a sub-band energy calculator (703) divides either the low end or the high end frequency band of the conversion coefficient into a plurality of sub-bands, an importance assessment unit (704) sets a degree of importance for each sub-band, a sparse processor (705), according to the set importance, sets the amplitude value of a specific number of conversion coefficients, from among the plurality of conversion coefficients included in each sub-band, at zero, and a correlation analysis unit (706) calculates the correlation between the corrected conversion coefficient of one frequency band and the conversion coefficient of the other frequency band.

### TECHNICAL FIELD

The present invention relates to a coding apparatus and a coding method used for a communication system that encodes and transmits a signal.

### BACKGROUND ART

Compression/coding techniques are often used when transmitting a speech signal and/or a sound signal in a packet communication system represented by Internet communication or a mobile communication system or the like, to improve transmission efficiency of the speech signal and/or the sound signal. In addition to simply encoding the speech signal and/or the sound signal at a low bit rate, there is also a growing demand for a technique for encoding a wider band speech signal and/or sound signal and a technique for encoding/decoding with a low amount of processing calculation without causing degradation of sound quality.

Various techniques for satisfying such demands are being developed to reduce the amount of processing calculation without causing quality degradation of a decoded signal. For example, according to a technique disclosed in PTL 1, the amount of processing calculation in pitch period search (adaptive codebook search) is reduced in a code excited linear prediction (CELP) type coding apparatus. More specifically, the coding apparatus sparsifies the update of an adaptive codebook. In a processing method for the sparsification, in the case where the amplitude of a sample does not exceed a given threshold, the value of the sample is replaced with zero (0). In this way, processing (more specifically, multiplication processing) on a portion in which the value of the sample is 0 is omitted at the time of the pitch period search, whereby the amount of calculation is reduced. PTL 1 also discloses a configuration in which the threshold is set to be adaptively variable for each process. PTL 1 also discloses a configuration in which: samples are ranked in descending order of absolute values of samples; and the values of samples other than a desired number of samples from the top in the ranking are replaced with zero (0).

PTL 2 discloses a technique concerning a reduction in the amount of calculation in correlation processing in a frequency domain. According to this technique, when a position at which a low-band spectrum similar to a high-band spectrum appears is specified through correlation analysis, a high-band spectrum whose amplitude value is small is replaced with zero. In this way, part of the processing necessary for the correlation analysis is omitted, whereby the amount of calculation is reduced.

### CITATION LIST

### Patent Literature

### PTL 1

Japanese Patent Application Laid-Open No. HEI 5-61499

### PTL 2

International Publication No. WO 2011/000408

### SUMMARY OF INVENTION

### Technical Problem

PTL 1 discloses, for example, a configuration in which the coding apparatus adaptively alters, for each process (subframe process), the threshold for selecting samples to be sparsified (samples whose value is replaced with zero (0)) at the time of the pitch period search. According to the above-mentioned method, however, although the average amount of processing calculation over an entire frame can be reduced in some cases, subframes in which the amount of calculation can be reduced and subframes in which the amount of calculation cannot be reduced mixedly exist, so that the amount of processing calculation is not necessarily reduced in frame-based processing. In other words, the above-mentioned method cannot guarantee a reduction in the amount of processing calculation in the worst case (the amount of processing calculation in a frame in which the amount of processing calculation is largest). Accordingly, the amount of processing calculation needs to be significantly reduced also in subframe-based processing, without causing quality degradation of a decoded signal. Similarly, in the case where correlation processing in a frequency domain is performed as in PTL 2, the amount of processing calculation needs to be significantly reduced also in subband-based processing within one frame without causing quality degradation of a decoded signal.

An object of the present invention is to provide a coding apparatus and a coding method that can reliably reduce the amount of subframe-based processing calculation or the amount of subband-based processing calculation (reduce the amount of processing calculation in the worst case) without causing quality degradation of a decoded signal when a correlation operation such as pitch period search is performed at the time of input signal coding.

### Solution to Problem

A coding apparatus according to an aspect of the present invention includes: an acquisition section that acquires transform coefficients whose frequency band is divided between a low-band part and a high-band part; a division section that divides one frequency band of the low-band part and high-band part of the transform coefficients into a plurality of subbands; a setting section that sets a degree of importance for each of the subbands; a changing section that changes, to zero, amplitude values of a predetermined number of transform coefficients of the plurality of transform coefficients included in each of the subbands, in accordance with the set degree of importance; and a calculation section that calculates a correlation between the changed transform coefficients in the one frequency band and the transform coefficients in the other frequency band.

A coding method according to an aspect of the present invention includes: acquiring transform coefficients whose frequency band is divided between a low-band part and a high-band part; dividing one frequency band of the low-band part and the high-band part of the transform coefficients into a plurality of subbands; setting a degree of importance for each of the subbands; changing, to zero, amplitude values of a predetermined number of transform coefficients of the transform coefficients included in each of the subbands, in accordance with the set degree of importance; and calculating a correlation between the changed transform coefficients in the one frequency band and the transform coefficients in the other frequency band.

### Advantageous Effects of Invention

According to the present invention, when a correlation operation is performed on an input signal, samples (transform coefficients) used for the correlation operation are adaptively adjusted for each process, whereby the amount of processing calculation can be remarkably reduced while quality degradation of an output signal is suppressed. The degree of importance of each subframe (the degree of importance of each subband) is determined in advance over an entire frame, and the number of samples (or transform coefficients) used for the correlation operation is determined for each subframe (each subband) in accordance with each degree of importance, whereby a reduction in the amount of processing calculation in the worst case can be guaranteed.

### BRIEF DESCRIPTION OF DRAWINGS

FIG. 1 is a block diagram illustrating a configuration of a communication system including a coding apparatus and a decoding apparatus according to Embodiment 1 of the present invention;

FIG. 2 is a block diagram illustrating a principal internal configuration of the coding apparatus illustrated in FIG. 1 according to Embodiment 1 of the present invention;

FIG. 3 is a block diagram illustrating a principal internal configuration of a CELP coding section illustrated in FIG. 2 according to Embodiment 1 of the present invention;

FIG. 4 is a block diagram illustrating a principal internal configuration of the decoding apparatus illustrated in FIG. 1 according to Embodiment 1 of the present invention;

FIG. 5 is a block diagram illustrating a principal internal configuration of a coding apparatus according to Embodiment 2 of the present invention;

FIG. 6 is a block diagram illustrating a principal internal configuration of a high-band signal coding section illustrated in FIG. 5 according to Embodiment 2 of the present invention;

FIG. 7 is a block diagram illustrating a principal internal configuration of a decoding apparatus according to Embodiment 2 of the present invention;

FIG. 8 is a block diagram illustrating a principal internal configuration of a high-band signal decoding section illustrated in FIG. 7 according to Embodiment 2 of the present invention; and

FIG. 9 is a block diagram illustrating a principal internal configuration of a high-band signal coding section of a coding apparatus according to Embodiment 3 of the present invention.

### DESCRIPTION OF EMBODIMENTS

Hereinafter, embodiments of the present invention will be described in detail with reference to the accompanying drawings. A speech coding apparatus and a speech decoding apparatus will be described as an example of the coding apparatus and decoding apparatus according to the present invention.

### Embodiment 1

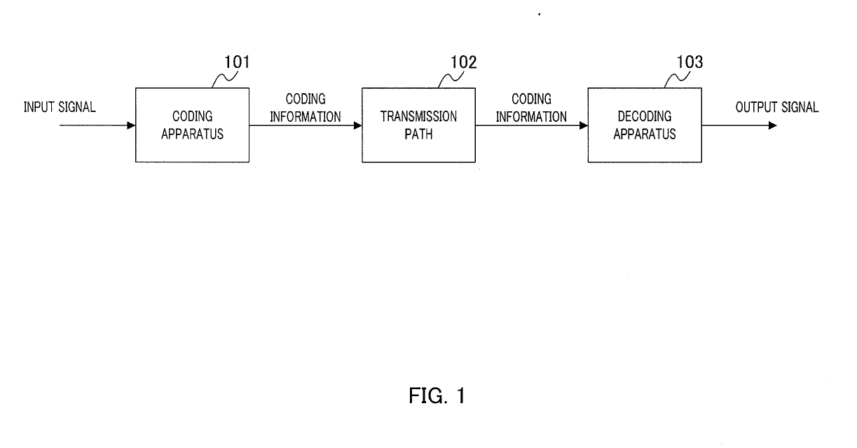

FIG. 1 is a block diagram illustrating a configuration of a communication system including a coding apparatus and a decoding apparatus according to Embodiment 1 of the present invention. In FIG. 1, the communication system includes coding apparatus 101 and decoding apparatus 103, which are communicable with each other via transmission path 102. Both of coding apparatus 101 and decoding apparatus 103 are normally used while being mounted on a base station apparatus, a communication terminal apparatus, or the like.

Coding apparatus 101 divides an input signal into blocks of N samples (N=1, 2, . . . ) each and encodes the input signal in frame units, with one frame including N samples. The input signal to be encoded is expressed as xₙ (n=0, . . . , N−1) in this case. Symbol n represents an (n+1)-th signal element of the input signal divided into blocks of N samples. Coding apparatus 101 transmits encoded input information (coding information) to decoding apparatus 103 via transmission path 102.

Decoding apparatus 103 receives the coding information transmitted from coding apparatus 101 via transmission path 102, decodes the coding information and obtains an output signal.

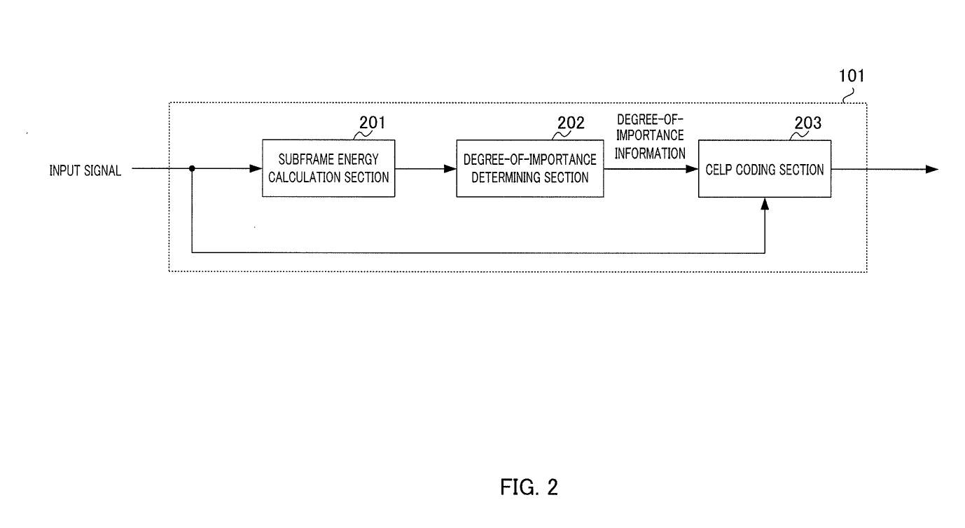

FIG. 2 is a block diagram illustrating an internal configuration of coding apparatus 101 shown in FIG. 1. Coding apparatus 101 mainly includes subframe energy calculation section 201, degree-of-importance determining section 202, and CELP coding section 203. It is assumed that subframe energy calculation section 201 and degree-of-importance determining section 202 perform processing in frame units and that CELP coding section 203 performs processing in subframe units. Hereinafter, details of each process will be described.

Subframe energy calculation section 201 receives an input signal. Subframe energy calculation section 201 first divides the received input signal into subframes. Hereinafter, a configuration will be described in which input signal Xₙ (n=0, . . . , N−1, that is, N samples) is divided into, for example, Nₛ subframes (subframe index k=0 to Nₛ−1).

Then, subframe energy calculation section 201 calculates subframe energy Eₖ (k=0, . . . , Nₛ−1) for each divided subframe according to expression 1. Then, subframe energy calculation section 201 outputs calculated subframe energy Eₖ to degree-of-importance determining section 202. Here, it is assumed that startₖ and endₖ in expression 1 indicate the leading sample index and the tail-end sample index, respectively, of a subframe whose subframe index is k.

$$\begin{matrix}[ 1 ] & \\ {E}_{k} = {\sum }_{i = {start}_{k}}^{{end}_{k}} {( {X}_{i} )}^{2} ( k = 0 , … , {N}_{s} - 1 ) & ( Expression 1 )\end{matrix}$$

Degree-of-importance determining section 202 receives subframe energy Eₖ (k=0, . . . , Nₛ−1) from subframe energy calculation section 201. Degree-of-importance determining section 202 sets the degree of importance of each subframe on the basis of the subframe energy. More specifically, degree-of-importance determining section 202 sets a higher degree of importance to a subframe whose subframe energy is larger. Hereinafter, the degree of importance set to each subframe is referred to as degree-of-importance information. Hereinafter, the degree-of-importance information is represented by Iₖ (k=0, . . . , Nₛ−1), and it is assumed that Iₖ having a smaller value indicates a higher degree of importance. For example, degree-of-importance determining section 202 sorts subframe energies Eₖ, respectively, of the received subframes in descending order, and sets a higher degree of importance (that is, degree-of-importance information Iₖ having a smaller value) in order from a subframe corresponding to the leading subframe energy after the sorting (a subframe whose subframe energy is largest).

For example, in the case where subframe energies Eₖ satisfy a relation of expression 2, degree-of-importance determining section 202 sets the degree of importance (degree-of-importance information Iₖ) of each subframe (a processing unit of CELP coding) as shown in expression 3.

[2]

E₀≧E₂≧E₁≧E₃ (Expression 2)

[3]

I₀=1

I₁=3

I₂=2

I₃=4 (Expression 3)

That is, degree-of-importance determining section 202 sets a higher degree of importance (degree-of-importance information Iₖ having a smaller value) to a subframe whose subframe energy Eₖ is larger. Here, the respective pieces of degree-of-importance information Iₖ of the subframes within one frame are different from one another in expression 3. Namely, degree-of-importance determining section 202 sets the degrees of importance such that the respective pieces of degree-of-importance information Iₖ of the subframes within one frame are always different from one another.

Then, degree-of-importance determining section 202 outputs set degree-of-importance information Iₖ (k=0, . . . , Nₛ−1) to CELP coding section 203. In expression 2 and expression 3, an example case where the number of subframes is 4 has been described, but the number of subframes is not limited in the present invention, and the present invention is similarly applicable to the numbers of subframes other than 4 given as an example. Furthermore, expression 3 shows example setting of degree-of-importance information Iₖ, and the present invention is similarly applicable to setting thereof using values other than those in expression 3.

CELP coding section 203 receives the input signal, and receives degree-of-importance information Iₖ (k=0, . . . , Nₛ−1) from degree-of-importance determining section 202. CELP coding section 203 encodes the input signal using the received degree-of-importance information. Hereinafter, details of coding processing by CELP coding section 203 will be described.

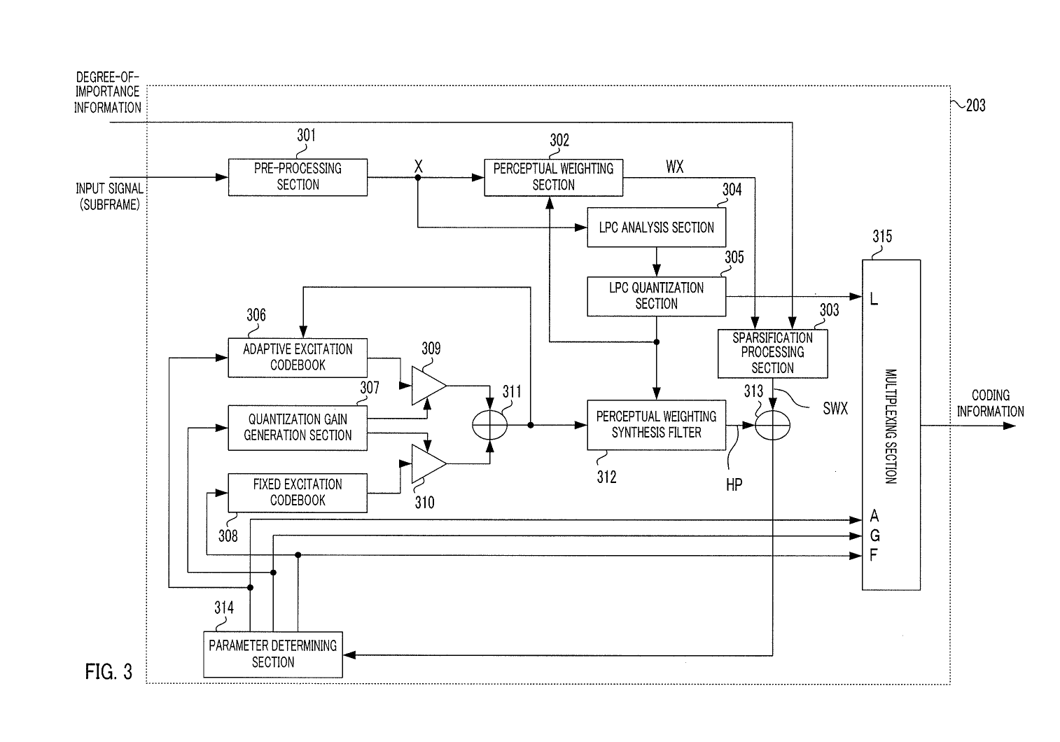

FIG. 3 is a block diagram illustrating an internal configuration of CELP coding section 203. CELP coding section 203 mainly includes pre-processing section 301, perceptual weighting section 302, sparsification processing section 303, linear prediction coefficient (LPC) analysis section 304, LPC quantization section 305, adaptive excitation codebook 306, quantization gain generation section 307, fixed excitation codebook 308, multiplying sections 309 and 310, adding sections 311 and 313, perceptual weighting synthesis filter 312, parameter determining section 314, and multiplexing section 315. Hereinafter, details of each processing section will be described.

Pre-processing section 301 performs, on input signal xₙ, high pass filter processing of removing a DC component and waveform shaping processing or pre-emphasis processing for improving the performance of subsequent coding processing. Pre-processing section 301 outputs input signal Xₙ (n=0, . . . , N−1) obtained by applying the processing to perceptual weighting section 302 and LPC analysis section 304.

Perceptual weighting section 302 performs perceptual weighting on input signal Xₙ outputted from pre-processing section 301, using quantized LPCs outputted from LPC quantization section 305, and generates perceptually-weighted input signal WXₙ (n=0, . . . , N−1). Then, perceptual weighting section 302 outputs perceptually-weighted input signal WXₙ to sparsification processing section 303.

Sparsification processing section 303 performs sparsification processing on perceptually-weighted input signal WXₙ received from perceptual weighting section 302, using degree-of-importance information Iₖ (k=0, . . . , Nₛ−1) received from degree-of-importance determining section 202 (FIG. 2). That is, sparsification processing section 303 performs sparsification processing of changing, to zero, the amplitude values of a predetermined number of samples of a plurality of samples (sample indexes startₖ to endₖ) constituting input signal WX in each subframe k. Hereinafter, details of the sparsification processing will be described.

Sparsification processing section 303 performs the sparsification processing on received perceptually-weighted input signal WXₙ on the basis of the received degree-of-importance information Iₖ (k=0, . . . , Nₛ−1). Here, as an example of the sparsification processing, processing of: selecting a predetermined number of samples in descending order from the largest absolute value of amplitude; and changing the values of the other samples to 0 is performed on perceptually-weighted input signal WXₙ. In this example, the predetermined number is adaptively determined on the basis of degree-of-importance information Iₖ (k=0, . . . , Nₛ−1). A setting example of the predetermined number when degree-of-importance information Iₖ (k=0, . . . , Nₛ−1) is as shown in expression 3 is shown in expression 4 given below. Here, it is assumed that the predetermined number is represented by Tₖ (k=0, . . . , Nₛ−1), and expression 4 shows an example case where the number Nₛ of subframes is 4.

[4]

T₀=12

T₁=6

T₂=10

T₃=8 (Expression 4)

In the case of expression 4, for the first subframe (subframe index k=0), sparsification processing section 303 performs, on perceptually-weighted input signal WXₙ (n=start₀ to end₀), processing of: selecting a predetermined number (T₀=12) of samples in descending order from the largest absolute value of amplitude; and setting the values of the other samples than the selected samples to 0. Similarly, for the second subframe (subframe index k=1), sparsification processing section 303 performs, on perceptually-weighted input signal WXₙ (n=start₁ to endₛ), processing of: selecting a predetermined number (T₁=6) of samples in descending order from the largest absolute value of amplitude; and setting the values of the other samples than the selected samples to 0. Also for the third subframe (subframe index k=2) and the fourth subframe (subframe index k=3), sparsification processing section 303 performs similar processing.

That is, sparsification processing section 303 sets larger predetermined number Tₖ to a subframe whose value of degree-of-importance information Iₖ is smaller (a subframe whose degree of importance is higher). In other words, sparsification processing section 303 sets a smaller number of samples whose amplitude value is changed to zero, to a subframe whose value of degree-of-importance info illation Iₖ is smaller (a subframe whose degree of importance is higher). Furthermore, sparsification processing section 303 changes, to zero, the amplitude values of a predetermined number (that is, the number of samples within one subframe−Tₖ) of samples whose amplitude value is smaller, of the plurality of samples constituting the input signal in each subframe.

Then, sparsification processing section 303 outputs the input signal after the sparsification processing (sparsified perceptually-weighted input signal SWXₙ) to adding section 313.

LPC analysis section 304 performs linear predictive analysis using input signal Xₙ outputted from pre-processing section 301 and outputs the analysis result (linear prediction coefficients: LPCs) to LPC quantization section 305.

LPC quantization section 305 performs quantization processing on the linear prediction coefficients (LPCs) outputted from LPC analysis section 304 and outputs the obtained quantized LPCs to perceptual weighting section 302 and perceptual weighting synthesis filter 312. Furthermore, LPC quantization section 305 outputs a code (L) representing the quantized LPCs to multiplexing section 315.

Adaptive excitation codebook 306 stores, in a buffer, excitation that is outputted in the past from adding section 311, extracts samples corresponding to one frame from the past excitation specified by a signal outputted from parameter determining section 314 (to be described later), as an adaptive excitation vector, and outputs the samples to multiplying section 309.

Quantization gain generation section 307 outputs a quantization adaptive excitation gain and a quantization fixed excitation gain specified by a signal outputted from parameter determining section 314 to multiplying section 309 and multiplying section 310 respectively.

Fixed excitation codebook 308 outputs a pulse excitation vector having a shape specified by a signal outputted from parameter determining section 314 to multiplying section 310 as a fixed excitation vector. Fixed excitation codebook 308 may output a vector obtained by multiplying the pulse excitation vector by a spreading vector to multiplying section 310 as the fixed excitation vector.

Multiplying section 309 multiplies the adaptive excitation vector outputted from adaptive excitation codebook 306 by the quantization adaptive excitation gain outputted from quantization gain generation section 307, and outputs the adaptive excitation vector multiplied by the gain to adding section 311. Furthermore, multiplying section 310 multiplies the fixed excitation vector outputted from fixed excitation codebook 308 by the quantization fixed excitation gain outputted from quantization gain generation section 307, and outputs the fixed excitation vector multiplied by the gain to adding section 311.

Adding section 311 performs vector addition on the adaptive excitation vector multiplied by the gain outputted from multiplying section 309 and the fixed excitation vector multiplied by the gain outputted from multiplying section 310 and outputs excitation, which is the addition result, to perceptual weighting synthesis filter 312 and adaptive excitation codebook 306. The excitation outputted to adaptive excitation codebook 306 is stored in the buffer of adaptive excitation codebook 306.

Perceptual weighting synthesis filter 312 performs filter synthesis on the excitation outputted from adding section 311, using filter coefficients based on the quantized LPCs outputted from LPC quantization section 305, thus generates synthesized signal HPₙ (n=0, . . . , N−1), and outputs synthesized signal HPₙ to adding section 313.

Adding section 313 inverts the polarity of synthesized signal HPₙ outputted from perceptual weighting synthesis filter 312, adds the synthesized signal with the inverted polarity to sparsified perceptually-weighted input signal SWXₙ outputted from sparsification processing section 303, thus calculates an error signal, and outputs the error signal to parameter determining section 314.

Parameter determining section 314 selects an adaptive excitation vector, a fixed excitation vector, and a quantization gain that minimize coding distortion of the error signal outputted from adding section 313, from adaptive excitation codebook 306, fixed excitation codebook 308, and quantization gain generation section 307 respectively, and outputs an adaptive excitation vector code (A), a fixed excitation vector code (F), and a quantization gain code (G) showing the selection results to multiplexing section 315.

Here, details of processing by adding section 313 and parameter determining section 314 will be described. Coding apparatus 101 obtains a correlation between: the input signal that has been subjected to particular processing (such as the pre-processing and the perceptual weighting processing); and the synthesized signal generated using the codebooks (adaptive excitation codebook 306 and fixed excitation codebook 308) and the filter coefficients based on the quantized LPCs, and thus encodes the input signal. More specifically, parameter determining section 314 searches for synthesized signal HPₙ (namely, indexes (codes (A), (F), and (G))) whose error (coding distortion) with sparsified perceptually-weighted input signal SWXₙ is minimum. At this time, the error is calculated in the following manner.

Normally, error Dₖ between the two signals (synthesized signal HPₙ and sparsified perceptually-weighted input signal SWXₙ) is calculated as shown in expression 5.

$$\begin{matrix} [ 5 ] & \\ {D}_{k} = {\sum }_{i = {start}_{k}}^{{end}_{k}} {( {SWX}_{i} )}^{2} - \frac{{\sum }_{i = {start}_{k}}^{{end}_{k}} {( ( {SWX}_{i} ) ( {HP}_{i} ) )}^{2}}{{\sum }_{i = {start}_{k}}^{{end}_{k}} {( {HP}_{i} )}^{2}} ( k = 0 , … , {N}_{s} - 1 ) & ( Expression 5 )\end{matrix}$$

In expression 5, the first term is energy of sparsified perceptually-weighted input signal SWXₙ, which is constant. This means that the second term needs to be maximized in order to minimize error Dₖ in expression 5. Here, in the present invention, sparsification processing section 303 limits samples targeted for calculation of the second term in expression 5, using degree-of-importance information Iₖ (k=0, . . . , Nₛ−1) outputted from degree-of-importance determining section 202 (FIG. 2), and reduces the amount of processing calculation of the second term.

More specifically, sparsification processing section 303 selects, for each subframe k, predetermined number Tₖ (set in accordance with degree-of-importance information Iₖ) of samples in descending order of absolute value of amplitude (in order from the largest absolute value of amplitude). As a result, the second term in expression 5 is calculated for only the selected samples. That is, adding section 313 calculates a correlation between: an input signal in each subframe, the input signal including a predetermined number of samples whose amplitude value is changed to zero, of a plurality of samples constituting the input signal; and a synthesized signal.

For example, in the case where degree-of-importance information Iₖ has values shown in expression 3, as shown in expression 4, for the first subframe (subframe index k=0), sparsification processing section 303 selects “12” (T₀=12) samples whose absolute value of amplitude is large (the top 12 samples in the ranking of absolute value of amplitude). Similarly, for the second subframe (subframe index k=1), sparsification processing section 303 selects “6” (T₁=6) samples whose absolute value of amplitude is large (the top 6 samples in the ranking of absolute value of amplitude). Also for the third subframe (subframe index k=2) and the fourth subframe (subframe index k=3), sparsification processing section 303 performs similar processing.

In this way, sparsification processing section 303 adaptively adjusts the number of samples targeted for calculation of the second term in expression 5, among the subframes within one frame. At this time, the values of the unselected samples are changed to zero (0), and hence parameter determining section 314 can omit multiplication processing of the second term in expression 5 for the unselected samples, so that the amount of processing calculation of expression 5 can be remarkably reduced. Furthermore, sparsification processing section 303 adjusts the number of selected samples for all the subframes within one frame, and hence the amount of processing calculation can be reduced for all the subframes, so that a reduction in the amount of processing calculation in the worst case can be guaranteed.

Multiplexing section 315 multiplexes: the code (L) representing the quantized LPCs outputted from LPC quantization section 305; and the adaptive excitation vector code (A), the fixed excitation vector code (F), and the quantization gain code (G) outputted from parameter determining section 314, and outputs the multiplexing result as coding information to transmission path 102.

Hereinabove, the processing by CELP coding section 203 illustrated in FIG. 2 has been described.

Hereinabove, the processing by coding apparatus 101 illustrated in FIG. 1 has been described.

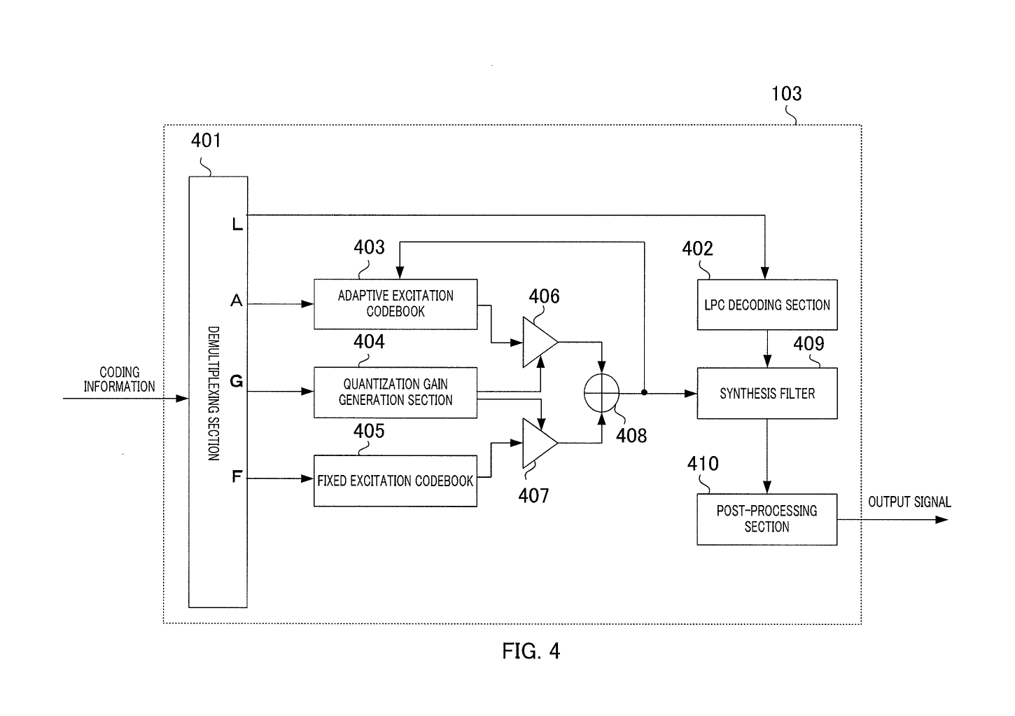

Next, an internal configuration of decoding apparatus 103 illustrated in FIG. 1 will be described with reference to FIG. 4. Here, the case where decoding apparatus 103 performs CELP type speech decoding will be described.

Demultiplexing section 401 demultiplexes the coding information received via transmission path 102 into individual codes ((L), (A), (G), and (F)). The demultiplexed LPC code (L) is outputted to LPC decoding section 402. The demultiplexed adaptive excitation vector code (A) is outputted to adaptive excitation codebook 403. The demultiplexed quantization gain code (G) is outputted to quantization gain generation section 404. The demultiplexed fixed excitation vector code (F) is outputted to fixed excitation codebook 405.

LPC decoding section 402 decodes the quantized LPCs from the code (L) outputted from demultiplexing section 401, and outputs the decoded quantized LPCs to synthesis filter 409.

Adaptive excitation codebook 403 extracts samples corresponding to one frame from past excitation specified by the adaptive excitation vector code (A) outputted from demultiplexing section 401, as adaptive excitation vectors, and outputs the samples to multiplying section 406.

Quantization gain generation section 404 decodes the quantization adaptive excitation gain and the quantization fixed excitation gain specified by the quantization gain code (G) outputted from demultiplexing section 401, outputs the quantization adaptive excitation gain to multiplying section 406, and outputs the quantization fixed excitation gain to multiplying section 407.

Fixed excitation codebook 405 generates a fixed excitation vector specified by the fixed excitation vector code (F) outputted from demultiplexing section 401, and outputs the fixed excitation vector to multiplying section 407.

Multiplying section 406 multiplies the adaptive excitation vector outputted from adaptive excitation codebook 403 by the quantization adaptive excitation gain outputted from quantization gain generation section 404, and outputs the adaptive excitation vector multiplied by the gain to adding section 408. On the other hand, multiplying section 407 multiplies the fixed excitation vector outputted from fixed excitation codebook 405 by the quantization fixed excitation gain outputted from quantization gain generation section 404, and outputs the fixed excitation vector multiplied by the gain to adding section 408.

Adding section 408 adds up the adaptive excitation vector multiplied by the gain outputted from multiplying section 406 and the fixed excitation vector multiplied by the gain outputted from multiplying section 407, generates excitation, and outputs the excitation to synthesis filter 409 and adaptive excitation codebook 403.

Synthesis filter 409 performs filter synthesis of the excitation outputted from adding section 408, using the filter coefficients based on the quantized LPCs decoded by LPC decoding section 402, and outputs the synthesized signal to post-processing section 410.

Post-processing section 410 performs processing of improving the subjective quality of speech such as formant emphasis and pitch emphasis, processing of improving the subjective quality of static noise, and the like on the signal outputted from synthesis filter 409, and outputs the processed signal as an output signal.

Hereinabove, the processing by decoding apparatus 103 illustrated in FIG. 1 has been described.

Thus, according to the present embodiment, the coding apparatus that adopts the CELP type coding method first calculates subframe energy for each subframe over the entire frame. Subsequently, the coding apparatus sets the degree of importance of each subframe in accordance with the calculated subframe energy. Then, at the time of pitch period search in each subframe, the coding apparatus selects a predetermined number (set in accordance with the degree of importance) of samples whose absolute value of amplitude is large, performs error calculation on only the selected samples, and calculates an optimal pitch cycle. This configuration can guarantee a significant reduction in the amount of processing calculation over the entire frame.

The coding apparatus does not equally determine, for all the subframes, the number of samples targeted for the correlation calculation (distance calculation) at the time of the pitch period search, but can adaptively vary the number of samples in accordance with the degree of importance of each subframe. More specifically, the coding apparatus can perform the pitch period search with high accuracy on subframes whose subframe energy is large and which are perceptually important (subframes whose degree of importance is high). On the other hand, the coding apparatus can perform the pitch period search with low accuracy on subframes whose subframe energy is small and which have small influence on perception (subframes whose degree of importance is low), whereby the amount of processing calculation can be significantly reduced. This can suppress significant quality degradation of a decoded signal.

In the present embodiment, description has been given of an example configuration in which degree-of-importance determining section 202 (FIG. 2) determines the degree-of-importance information on the basis of the subframe energy calculated by subframe energy calculation section 201. The present invention is not limited to this configuration, and is similarly applicable to a configuration in which the degree of importance is determined on the basis of information other than the subframe energy. In another example configuration, the degree of signal variation (for example, spectral flatness measure (SFM)) of each subframe is calculated, and a higher degree of importance is set to a subframe whose SFM value is larger. As a matter of course, the degree of importance may be determined on the basis of information other than the SFM value.

In the present embodiment, sparsification processing section 303 (FIG. 3) fixedly determines a predetermined number (for example, expression 4) of samples targeted for the correlation calculation (error calculation) on the basis of the degree-of-importance information determined by degree-of-importance determining section 202 (FIG. 2). The present invention is not limited to this configuration, and is similarly applicable to a configuration in which the number of samples targeted for the correlation calculation (error calculation) is determined according to methods other than the determining method shown in expression 4. For example, in the case where the subframe energy values of high-ranked subframes are extremely close to each other, degree-of-importance determining section 202 may allow values with fractional values such as (1.0, 2.5, 2.5, 4.0) to be used for setting of the degree-of-importance information, instead of simply setting the degree-of-importance information using integer values of (1, 2, 3, 4). That is, the degree-of-importance information may be more finely set in accordance with a difference in subframe energy among the subframes. In another example configuration, sparsification processing section 303 sets the predetermined number (the predetermined number of samples) such as (12, 8, 8, 6) on the basis of the degree-of-importance information. In this way, sparsification processing section 303 determines the predetermined number of samples using more flexible weighting (degree of importance) in accordance with subframe energy distribution of the plurality of subframes, whereby the amount of processing calculation can be reduced more efficiently than in the above-mentioned embodiment. The predetermined number of samples can be determined by preparing a plurality of pattern sets of the predetermined number of samples in advance. Alternatively, the predetermined number of samples can also be dynamically determined on the basis of the degree-of-importance information. Both the configurations presuppose that patterns of the predetermined number of samples are determined or the predetermined number of samples is dynamically determined such that the amount of processing calculation can be reduced by a given value or more over the entire frame.

In the present embodiment, description has been given of the case where the sparsification processing is performed on the input signal (here, sparsified perceptually-weighted input signal SWXₙ). In the present invention, not limited to the input signal, even if the sparsification processing is performed on the synthesized signal (here, synthesized signal HPₙ) whose correlation with the input signal is calculated, effects similar to those in the above-mentioned embodiment can be obtained. Namely, the coding apparatus may modify, to zero, the amplitude values of a predetermined number of samples of a plurality of samples constituting at least one signal of the input signal and the synthesized signal in each subframe, in accordance with the degree of importance set to each subframe, and may calculate a correlation between the input signal and the synthesized signal. Furthermore, the present invention is similarly applicable to a configuration in which, for both the input signal and the synthesized signal in each subframe, the coding apparatus changes, to zero, the amplitude values of a predetermined number of samples of a plurality of samples constituting each signal, and calculates a correlation between the input signal and the synthesized signal.

In the present embodiment, description has been given of the case where the sparsification processing is performed on sparsified perceptually-weighted input signal SWXₙ. The present invention is similarly applicable to the case where the pre-processing by pre-processing section 301 and the perceptual weighting processing by perceptual weighting section 302 are not performed on the input signal. In this case, sparsification processing section 303 performs the sparsification processing on input signal Xₙ.

In the present embodiment, an example configuration in which CELP coding section 203 adopts the CELP type coding method has been described. The present invention is not limited to this configuration, and is similarly applicable to coding methods other than the CELP type coding method. In another example configuration, the present invention is applied to a signal correlation operation between frames when coding parameters in a current frame are calculated using an encoded signal in a past frame without performing LPC analysis.

### Embodiment 2

In Embodiment 1, the correlation analysis processing in the time domain has been described. In comparison, in the present embodiment, correlation analysis processing in a frequency domain will be described.

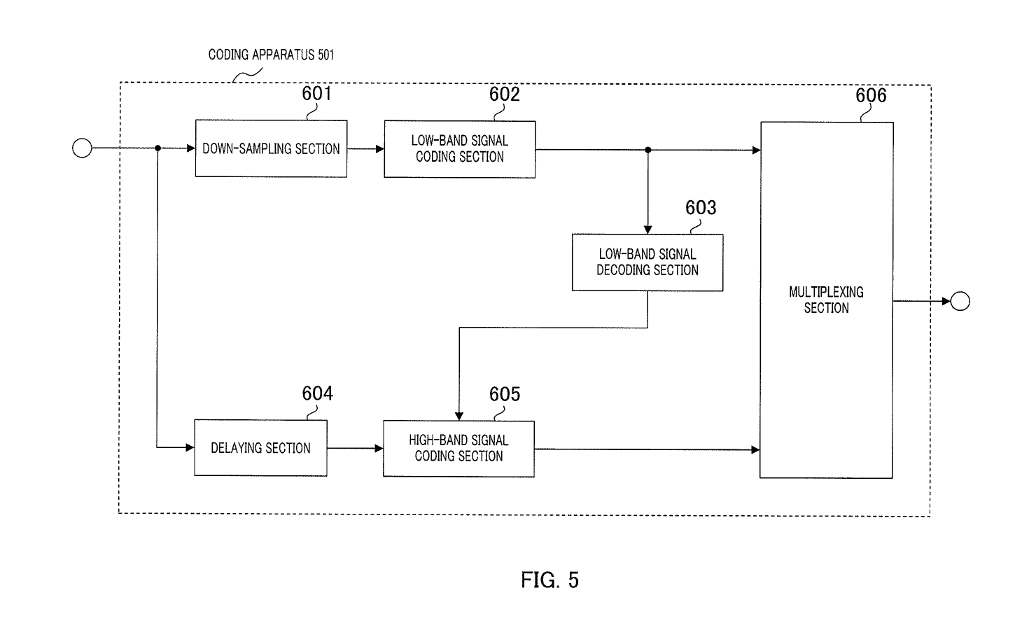

FIG. 5 is a block diagram illustrating an internal configuration of coding apparatus 501 of the present embodiment.

Coding apparatus 501 mainly includes an input terminal, down-sampling section 601, low-band signal coding section 602, low-band signal decoding section 603, delaying section 604, high-band signal coding section 605, multiplexing section 606, and an output terminal.

A digitized speech signal or a digitized music signal is inputted to the input terminal.

Down-sampling section 601 down-samples the input signal received via the input terminal and generates a signal having a low sampling rate. Down-sampling section 601 outputs the down-sampled signal to low-band signal coding section 602.

Low-band signal coding section 602 encodes the down-sampled signal received from down-sampling section 601. Low-band signal coding section 602 outputs the obtained coding code to low-band signal decoding section 603 and multiplexing section 606 (multiplexer).

Low-band signal decoding section 603 generates a decoded low-band signal using the coding code received from low-band signal coding section 602. Low-band signal decoding section 603 outputs the generated decoded low-band signal to high-band signal coding section 605.

Delaying section 604 gives a delay having a predetermined length to the input signal received via the input terminal, and outputs the delayed input signal to high-band signal coding section 605.

High-band signal coding section 605 encodes a high-band part of the input signal received from delaying section 604, using the decoded low-band signal received from low-band signal decoding section 603. High-band signal coding section 605 outputs the generated coding code to multiplexing section 606.

Multiplexing section 606 multiplexes the coding code received from low-band signal coding section 602 and the coding code received from high-band signal coding section 605 and outputs the multiplexing result as coding information via the output terminal.

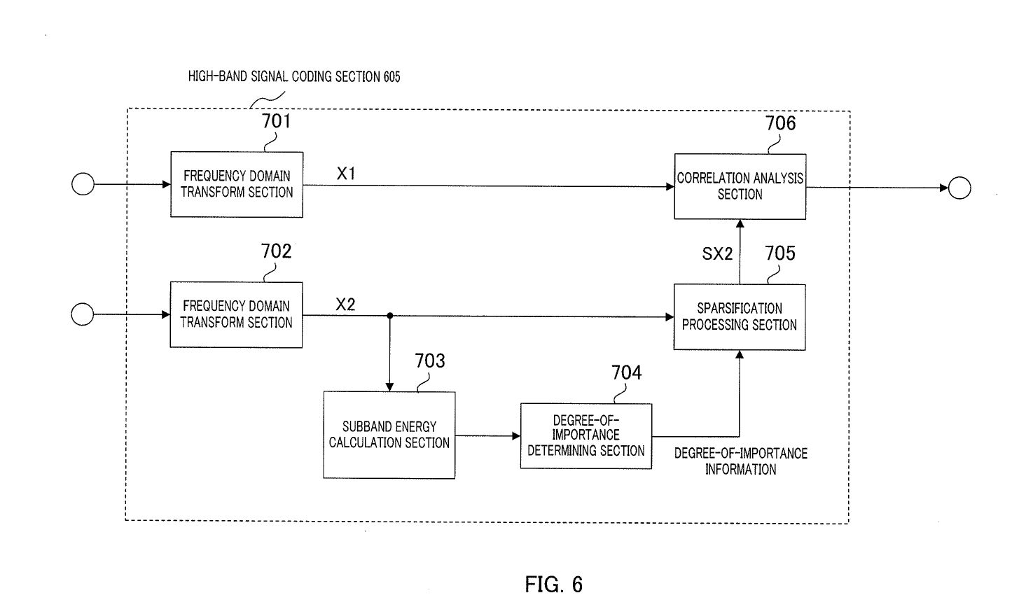

FIG. 6 is a block diagram illustrating an internal configuration of high-band signal coding section 605. High-band signal coding section 605 mainly includes input terminals, frequency domain transform sections 701 and 702, subband energy calculation section 703, degree-of-importance determining section 704, sparsification processing section 705, correlation analysis section 706, and an output terminal.

The decoded low-band signal is inputted from low-band signal decoding section 603 (FIG. 5) to the input terminal connected to frequency domain transform section 701. Furthermore, the delayed input signal is inputted from delaying section 604 to the input terminal connected to frequency domain transform section 702.

Frequency domain transform section 701 performs frequency transform on the decoded low-hand signal received via the input terminal, and calculates decoded low-band spectrum X1ₖ.

Frequency domain transform section 702 performs frequency transform on the input signal received via the input terminal, and calculates input spectrum X2ₖ.

Here, discrete Fourier transform (DFT), discrete cosine transform (DCT), changed discrete cosine transform (MDCT), and the like are applied to the frequency transform by frequency domain transform sections 701 and 702. Hereinafter, a spectrum may also be referred to as transform coefficients in some cases. That is, frequency domain transform section 702 acquires input spectrum X2ₖ. The frequency band of input spectrum (transform coefficients) X2ₖ can be divided between a high-band part and a low-band part. Furthermore, frequency domain transform section 701 acquires decoded low-band spectrum X1ₖ corresponding to a low-band part of the spectrum of the input signal (input spectrum).

Subband energy calculation section 703 receives the input spectrum from frequency domain transform section 702. Subband energy calculation section 703 first divides the high-band part of the received input spectrum into a plurality of subbands. Hereinafter, description will be given of, for example, a configuration in which high-band part X2ₖ (k=0, . . . , K−1; that is, K transform coefficients) of the input spectrum is divided into N_{M} subbands (subband index m=0 to N_{M}−1).

Subband energy calculation section 703 calculates, for each divided subband, subband energy Eₘ (m=0, . . . , N_{M}−1) of high-band part X2ₖ of the input spectrum according to expression 6. Then, subband energy calculation section 703 outputs calculated subband energy Eₘ to degree-of-importance determining section 704. In expression 6, startₘ and endₘ indicate the transform coefficient index of the lowest frequency and the transform coefficient index of the highest frequency, respectively, of the subband whose subband index is m.

$$\begin{matrix}[ 6 ] & \\ {E}_{m} = {\sum }_{k = {start}_{m}}^{{end}_{m}} {( X {2}_{k} )}^{2} ( m = 0 , … , {N}_{M} - 1 ) & ( Expression 6 )\end{matrix}$$

Degree-of-importance determining section 704 receives subband energy Eₘ (m=0, . . . , N_{M}−1) from subband energy calculation section 703. Degree-of-importance determining section 704 sets the degree of importance of each subband. For example, degree-of-importance determining section 704 sets the degree of importance of each subband on the basis of the subband energy. More specifically, degree-of-importance determining section 704 sets a higher degree of importance for a subband whose subband energy is larger. Hereinafter, the degree of importance set to each subband is referred to as degree-of-importance information. Hereinafter, the degree-of-importance information is represented by Iₘ (m=0, . . . , N_{M}−1), and it is assumed that Iₘ having a smaller value indicates a higher degree of importance. For example, degree-of-importance determining section 704 sorts respective received subband energies Eₘ of subbands in descending order, and sets a higher degree of importance (that is, degree-of-importance information Iₘ having a smaller value) in order from a subband corresponding to the leading subband energy after the sorting (a subband whose subband energy is largest).

For example, in the case where subband energies Eₘ satisfy the relation of expression 7, degree-of-importance determining section 704 sets the degree of importance (degree-of-importance information Iₘ) of each subband as shown in expression 8.

[7]

E₀≧E₂≧E₁≧E₃ (Expression 7)

[8]

I₀=1

I₁=3

I₂=2

I₃=4 (Expression 8)

That is, degree-of-importance determining section 704 sets a higher degree of importance (degree-of-importance information Iₘ having a smaller value) for a subband whose subband energy Eₘ is larger. Here, the respective pieces of degree-of-importance information Iₘ of the subbands are different from one another in expression 8. Namely, degree-of-importance determining section 704 sets the degrees of importance such that the respective pieces of degree-of-importance information Iₘ of the subbands are always different from one another.

Then, degree-of-importance determining section 704 outputs set degree-of-importance information Iₘ (m=0, . . . , N_{M}−1) to sparsification processing section 705. In expression 7 and expression 8, an example case where the number of subbands is 4 has been described, but the number of subbands is not limited in the present invention, and the present invention is similarly applicable to a case where the number of subbands is other than four described as an example. Furthermore, expression 8 shows mere example setting of degree-of-importance information Iₘ, and the present invention is similarly applicable a setting using values other than those used in expression 8.

Sparsification processing section 705 performs sparsification processing on high-band part X2ₖ of the input spectrum received from frequency domain transform section 702, using degree-of-importance information Iₘ (m=0, . . . , N_{M}−1) received from degree-of-importance determining section 704. For example, sparsification processing section 705 performs sparsification processing of changing, to zero, the amplitude values of a predetermined number of transform coefficients of a plurality of transform coefficients (transform coefficient indexes startₖ to endₖ) constituting high-band part X2ₖ of the input spectrum in each subband m. Hereinafter, details of the sparsification processing will be described.

Sparsification processing section 705 performs, in subband units, the sparsification processing on high-band part X2ₖ of the received input spectrum on the basis of the received degree-of-importance information Iₘ (m=0, . . . , N_{M}−1). Here, as an example of the sparsification processing, processing of: selecting a predetermined number of transform coefficients in descending order from the largest absolute value of amplitude; and changing the values of the other transform coefficients to 0 is performed on high-band part X2ₖ of the input spectrum. In this example, the predetermined number is adaptively determined on the basis of degree-of-importance information Iₘ (m=0, . . . , M_{M}−1). A setting example of the predetermined number when degree-of-importance information (m=0, . . . , N_{M}−1) is as shown in expression 8 is shown in expression 9 given below. Here, it is assumed that the predetermined number is represented by Tₘ (m=0, . . . , N_{M}−1), and expression 9 shows an example case where the number N_{M} of subbands is 4.

[9]

T₀=12

T₁=6

T₂=10

T₃=8 (Expression 9)

In the case of expression 9, for the first subband (subband index m=0), sparsification processing section 705 performs, on high-band part X2ₖ (k=start₀ to end₀) of the input spectrum, processing of: selecting a predetermined number (T₀=12) of transform coefficients in descending order from the largest absolute value of amplitude; and setting (changing) the values of the other transform coefficients than the selected transform coefficients to 0. Similarly, for the second subband (subband index m=1), sparsification processing section 705 performs, on high-band part X2ₖ (k=startₛ to endₛ) of the input spectrum, processing of: selecting a predetermined number (T₁=6) of transform coefficients in descending order from the largest absolute value of amplitude; and setting (changing) the values of the other transform coefficients than the selected transform coefficients to 0. Also for the third subband (subband index m=2) and the fourth subband (subband index m=3), sparsification processing section 705 performs similar processing.

That is, sparsification processing section 705 sets larger predetermined number Tₘ for a subband whose value of degree-of-importance information Iₘ is smaller (a subband whose degree of importance is higher). In other words, sparsification processing section 705 sets a smaller number of transform coefficients whose amplitude value is changed to zero, for a subband whose value of degree-of-importance information Iₘ is smaller (a subband whose degree of importance is higher). Furthermore, sparsification processing section 705 sets (changes), to zero, the amplitude values of a predetermined number (that is, the number of transform coefficients within one subband−Tₘ) of transform coefficients whose amplitude value is smaller, of the plurality of transform coefficients constituting the high-band part of the input spectrum in each subband.

Then, sparsification processing section 705 outputs high-band part X2ₖ of the input spectrum after the sparsification processing (high-band part SX2ₖ of sparsified input spectrum) to correlation analysis section 706.

Correlation analysis section 706 analyzes, in subband units, a correlation between: decoded low-band spectrum X1ₖ (corresponding to the low-band part of the input spectrum) received from frequency domain transform section 701; and high-band part SX2ₖ of the input spectrum after the sparsification processing received from sparsification processing section 705, and obtains the amount of shift d when the correlation value is maximum. Then, correlation analysis section 706 outputs the amount of shift d of each subband to multiplexing section 606 (FIG. 5) via the output terminal. The correlation value between decoded low-band spectrum X1ₖ and high-band part SX2ₖ of the input spectrum after the sparsification processing is calculated according to expression 10.

$$\begin{matrix} [ 10 ] & \\ {Cor}_{m} ( d ) = \frac{{\sum }_{k = {start}_{m}}^{{end}_{m}} ( X {1}_{k - d} \cdot SX {2}_{k} )}{{\sum }_{k = {start}_{m}}^{{end}_{m}} {( SX {2}_{k} )}^{2}} ( m = 0 , … , {N}_{M} - 1 , {D}_{min} \leq d \leq {D}_{max} ) & ( Expression 10 )\end{matrix}$$

In expression 10, d represents the amount of shift, represents the minimum value of the search range for the amount of shift, Dₘₐₓ represents the maximum value of the search range for the amount of shift, and Corₘ(d) represents the correlation value at amount of shift d in the m^{th} subband.

Correlation analysis section 706 obtains the amount of shift dmax when the correlation value is maximum, on the basis of correlation value Corₘ(d) calculated according to expression 10, performs coding with the obtained amount of shift dmax being set as the amount of shift in the m^{th} subband, and outputs the resultant coding code to multiplexing section 606 (FIG. 5). That is, correlation analysis section 706 calculates the correlation value for obtaining the amount of shift dmax indicating the transform coefficients in the low-band part (decoded low-band spectrum) most similar to the transform coefficients in the high-band part (the high-band part of the input spectrum).

In this way, in the present embodiment, sparsification processing section 705 reduces the amount of processing calculation at the time of the calculation of expression 10, using degree-of-importance information Iₘ (m=0, . . . , N_{M}−1) outputted from degree-of-importance determining section 704.

More specifically, sparsification processing section 705 selects, for each subband m, predetermined number Tₘ (set in accordance with degree-of-importance information Iₘ) of transform coefficients in descending order of absolute value of amplitude (in order from the largest absolute value of amplitude). As a result, the processing in expression 10 is performed on only the selected transform coefficients. That is, correlation analysis section 706 calculates a correlation between: a high-band part of an input spectrum in each subband, the high-band part of the input spectrum including a predetermined number of transform coefficients whose amplitude value is changed to zero, in a plurality of subbands constituting the high-band part of the input spectrum; and a decoded low-band spectrum.

For example, in the case where degree-of-importance information Iₘ has values indicated in expression 8, as shown in expression 9, for the first subband (subband index m=0), sparsification processing section 705 selects “12” (T₀=12) transform coefficients whose absolute value of amplitude is large (the top 12 transform coefficients in the ranking of absolute value of amplitude). Similarly, for the second subband (subband index m=1), sparsification processing section 705 selects “6” (T₁=6) transform coefficients whose absolute value of amplitude is large (the top 6 transform coefficients in the ranking of absolute value of amplitude). Also for the third subband (subband index m=2) and the fourth subband (subband index m=3), sparsification processing section 705 performs similar processing.

In this way, sparsification processing section 705 adaptively adjusts the number of transform coefficients targeted for calculation of the correlation value in expression 10, among the subbands within the frame. At this time, the values of the unselected transform coefficients are changed to zero (0), and hence correlation analysis section 706 can omit part of the processing in expression 10, so that the amount of processing calculation of expression 10 can be remarkably reduced. Furthermore, sparsification processing section 705 adjusts the number of selected transform coefficients among all the subbands within one frame, and hence the amount of processing calculation can be reduced for all the subbands, so that the amount of processing calculation in the worst case can be remarkably reduced.

Hereinabove, the processing by coding apparatus 501 according to the present embodiment has been described.

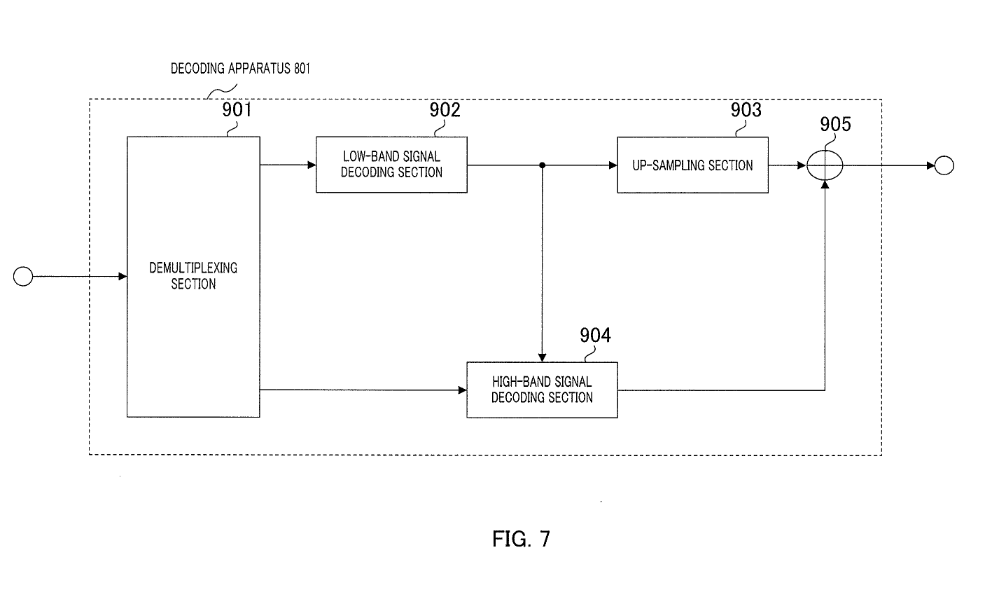

Next, processing by a decoding apparatus according to the present embodiment will be described. FIG. 7 is a block diagram illustrating an internal configuration of decoding apparatus 801 according to the present embodiment.

Decoding apparatus 801 mainly includes an input terminal, demultiplexing section 901, low-band signal decoding section 902, up-sampling section 903, high-band signal decoding section 904, adding section 905, and an output terminal.

Coding information is inputted to the input terminal. Demultiplexing section 901 demultiplexes the coding information received via the input terminal into a coding code for low-band signal decoding section 902 and a coding code for high-band signal decoding section 904.

The coding code for low-band signal decoding section 902 is the coding code of the down-sampled signal encoded by low-band signal coding section 602 (FIG. 5) of coding apparatus 501. Furthermore, the coding code for high-band signal decoding section 904 is the coding code of the amount of shift (information indicating the position of a low-band spectrum having the largest correlation value with a high-band spectrum) encoded by high-band signal coding section 605 (FIG. 5) of coding apparatus 501. The amount of shift is obtained for each subband by high-band signal coding section 605.

Low-band signal decoding section 902 generates a decoded low-band signal using the coding code obtained by demultiplexing section 901, and outputs the generated decoded low-band signal to up-sampling section 903 and high-band signal decoding section 904.

Up-sampling section 903 up-samples (increases the sampling frequency of) the decoded low-band signal received from low-band signal decoding section 902, and generates a signal having a high sampling rate. Up-sampling section 903 outputs the up-sampled signal to adding section 905.

High-band signal decoding section 904 receives the coding code demultiplexed by demultiplexing section 901 and the decoded low-band signal generated by low-band signal decoding section 902. High-band signal decoding section 904 performs decoding processing (to be described later), generates a decoded high-band signal, and outputs the generated decoded high-band signal to adding section 905.

Adding section 905 adds up the up-sampled decoded low-band signal received from up-sampling section 903 and the decoded high-band signal received from high-band signal decoding section 904, generates an output signal, and outputs the output signal to the output terminal.

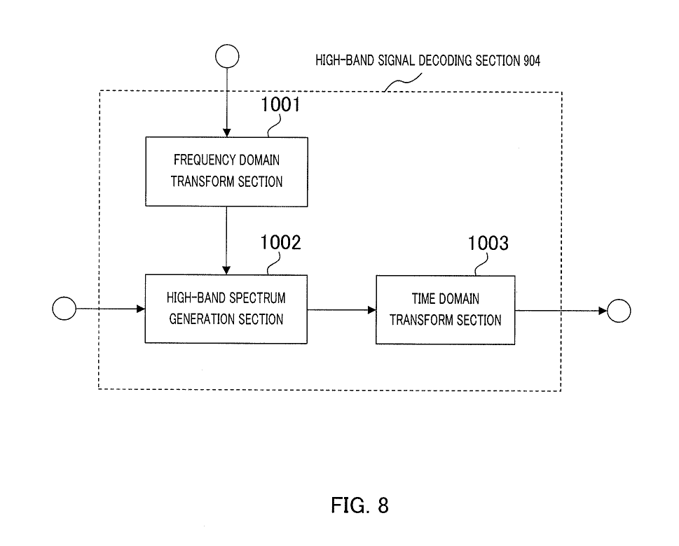

FIG. 8 is a block diagram illustrating an internal configuration of high-band signal decoding section 904. High-band signal decoding section 904 mainly includes input terminals, frequency domain transform section 1001, high-band spectrum generation section 1002, time domain transform section 1003, and an output terminal.

The decoded low-band signal is inputted from low-band signal decoding section 902 (FIG. 7) to the input terminal connected to frequency domain transform section 1001.

Furthermore, the coding code is inputted from demultiplexing section 901 (FIG. 7) to the input terminal connected to high-band spectrum generation section 1002.

Frequency domain transform section 1001 performs frequency transform on the decoded low-band signal received via the input terminal, and calculates decoded low-band spectrum X1(k). Discrete Fourier transform (DFT), discrete cosine transform (DCT), changed discrete cosine transform (MDCT), and the like are applied to the frequency transform by frequency domain transform section 1001. Frequency domain transform section 1001 outputs calculated decoded low-band spectrum X1(k) to high-band spectrum generation section 1002.

High-band spectrum generation section 1002 refers to the amount of shift of each subband on the basis of the coding code received via the input terminal, copies a spectrum indicated by the amount of shift to the high-band part from the decoded low-band spectrum received from frequency domain transform section 1001, and generates a decoded high-band spectrum. This copy processing is performed for each subband. High-band spectrum generation section 1002 outputs the generated decoded high-hand spectrum to time domain transform section 1003.

Time domain transform section 1003 transforms the decoded high-band spectrum received from high-band spectrum generation section 1002 into a time-domain signal, and outputs the time-domain signal via the output terminal. At this time, time domain transform section 1003 performs appropriate processing such as windowing and superposition addition, to thereby avoid discontinuity that otherwise occurs between frames.

Hereinabove, the processing by decoding apparatus 801 according to the present embodiment has been described.

Thus, according to the present embodiment, the coding apparatus first acquires transform coefficients (spectrum) whose frequency band is divided between a low-band part and a high-band part. Subsequently, the coding apparatus divides one frequency band of the low-band part and the high-band part (in the present embodiment, the high-band part) of the transform coefficients into a plurality of subbands. Subsequently, the coding apparatus sets the degree of importance of each subband. Then, the coding apparatus changes, to zero, the amplitude values of a predetermined number of transform coefficients of the transform coefficients included in each subband, in accordance with the set degree of importance. Then, the coding apparatus calculates a correlation between the transform coefficients in the low-band part and the changed transform coefficients in the high-band part. This configuration can guarantee a significant reduction in the amount of processing calculation over the entire frequency band (for all the plurality of subbands).

The coding apparatus does not equally determine, for all the subbands, transform coefficients targeted for the correlation calculation (amount-of-shift calculation), but can adaptively vary the transform coefficients in accordance with the degree of importance of each subband. More specifically, the coding apparatus can perform the amount-of-shift search with high accuracy on subbands whose subband energy is large and which are perceptually important (subbands whose degree of importance is high). On the other hand, the coding apparatus can perform the amount-of-shift search with low accuracy on subbands whose subband energy is small and which have small influence on perception (subbands whose degree of importance is low), whereby the amount of processing calculation can be significantly reduced. This can suppress significant quality degradation of a decoded signal.

### Embodiment 3

In Embodiment 2, the configuration in which the sparsification processing is performed on high-band part X2ₖ of the input spectrum has been described. In the present embodiment, the configuration in which the sparsification processing is performed on decoded low-band spectrum X1ₖ (that is, the low-band part of the input spectrum) will be described.

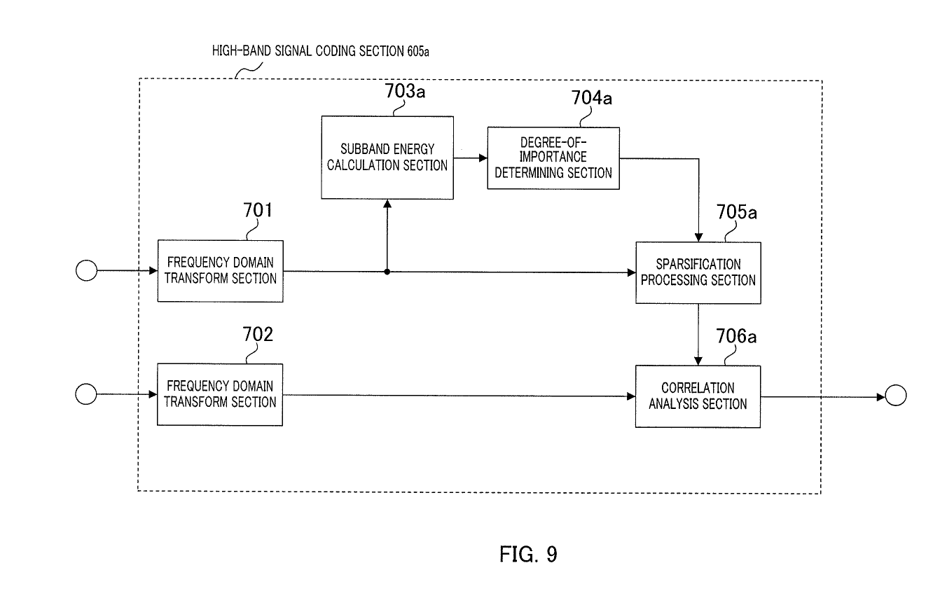

FIG. 9 illustrates a configuration of high-band signal coding section 605a according to the present embodiment. In FIG. 9, the same components as those in FIG. 6 (high-band signal coding section 605) are denoted by the same reference signs, and description thereof is omitted.

Subband energy calculation section 703a first divides the decoded low-band spectrum received from frequency domain transform section 701 into a plurality of subbands. Hereinafter, description will be given of, for example, a configuration in which decoded low-band spectrum X1ₖ (k=0, . . . , K−1; that is, K transform coefficients) is divided into N_{J} subbands (subband index j=0 to N_{J}−1).

Subband energy calculation section 703a calculates, for each divided subband, subband energy Eⱼ (j=0, . . . , N_{J}−1) of decoded low-band spectrum X1ₖ according to expression 11. Then, subband energy calculation section 703a outputs calculated subband energy Eⱼ to degree-of-importance determining section 704a. In expression 11, N_{J} indicates the number of subbands of the decoded low-band spectrum, and STARTⱼ and ENDⱼ indicate the transform coefficient index of the lowest frequency and the transform coefficient index of the highest frequency, respectively, of the subband whose subband index is j.

$$\begin{matrix}[ 11 ] & \\ {E}_{j} = {\sum }_{k = {START}_{j}}^{{END}_{j}} {( X {1}_{k} )}^{2} ( j = 0 , … , {N}_{J} - 1 ) & ( Expression 11 )\end{matrix}$$

Degree-of-importance determining section 704a receives subband energy Eⱼ (j=0, . . . , N_{J}−1) from subband energy calculation section 703a. Similarly to Embodiment 2 (degree-of-importance determining section 704), degree-of-importance determining section 704a sets degree-of-importance information Iⱼ of each subband on the basis of the subband energy.

Similarly to Embodiment 2 (sparsification processing section 705), sparsification processing section 705a performs sparsification processing on decoded low-band spectrum X1ₖ received from frequency domain transform section 701 using degree-of-importance information Iⱼ (j=0, . . . , N_{J}−1) received from degree-of-importance determining section 704a. For example, sparsification processing section 705a performs sparsification processing of changing, to zero, the amplitude values of a predetermined number of transform coefficients of a plurality of transform coefficients (transform coefficient indexes STARTⱼ to END) constituting decoded low-band spectrum X1ₖ in each subband j, and generates decoded low-band spectrum SX1ₖ after the sparsification processing. Sparsification processing section 705a outputs decoded low-band spectrum SX1ₖ after the sparsification processing to correlation analysis section 706a.

Correlation analysis section 706a analyzes a correlation between: decoded low-band spectrum SX1ₖ after the sparsification processing received from sparsification processing section 705a; and high-band part X2ₖ of the input spectrum received from frequency domain transform section 702, and obtains amount of shift d when the correlation value is maximum. Correlation analysis section 706a performs the correlation analysis in subband units obtained by dividing the high-band part of the input spectrum, and obtains amount of shift d when the correlation value is maximum, for each subband of the high-band part of the input spectrum. Correlation analysis section 706a outputs the amount of shift d of each subband of the high-band part of the input spectrum, to multiplexing section 606 (FIG. 5) via the output terminal. The correlation value between high-band part X2ₖ of the input spectrum and decoded low-band spectrum SX1ₖ after the sparsification processing is calculated according to expression 12.

$$\begin{matrix} [ 12 ] & \\ {Cor}_{m} ( d ) = \frac{{\sum }_{k = {start}_{m}}^{{end}_{m}} ( SX {1}_{k - d} \cdot X {2}_{k} )}{{\sum }_{k = {start}_{m}}^{{end}_{m}} {( X {2}_{k} )}^{2}} ( m = 0 , … , {N}_{M} - 1 , {D}_{min} \leq d \leq {D}_{max} ) & ( Expression 12 )\end{matrix}$$

In expression 12, N_{M} represents the number of subbands of the high-band part of the input spectrum, startₘ and endₘ represent the transform coefficient index of the lowest frequency and the transform coefficient index of the highest frequency, respectively, of the subband whose subband index is m (m=0, . . . , N_{M}−1), d represents the amount of shift, Dₘᵢₙ represents the minimum value of the search range for the amount of shift, Dₘₐₓ represents the maximum value of the search range for the amount of shift, and Corₘ(d) represents the correlation value at amount of shift d in the m^{th} subband.

Correlation analysis section 706a obtains the amount of shift dmax when the correlation value is maximum, on the basis of correlation value Corₘ(d) calculated as described above, performs coding with the obtained amount of shift dmax being set as the amount of shift in the m^{th} subband, and outputs the resultant coding code to multiplexing section 606 (FIG. 5). That is, correlation analysis section 706a calculates the correlation value for obtaining the amount of shift dmax indicating the transform coefficients in the low-band part (decoded low-band spectrum) most similar to the transform coefficients in the high-band part (the high-band part of the input spectrum).

In this way, in the present embodiment, sparsification processing section 705a reduces the amount of processing calculation at the time of the calculation of expression 12, using degree-of-importance information Iⱼ (j=0, . . . , N₁−1) outputted from degree-of-importance determining section 704a.

More specifically, according to the present embodiment, the coding apparatus first acquires transform coefficients (spectrum) whose frequency band is divided between a low-band part and a high-band part. Subsequently, the coding apparatus divides one frequency band of the low-band part and the high-band part (in the present embodiment, the low-band part) of the transform coefficients into a plurality of subbands. Subsequently, the coding apparatus sets the degree of importance of each subband. Then, the coding apparatus changes, to zero, the amplitude values of a predetermined number of transform coefficients of the transform coefficients included in each subband, in accordance with the set degree of importance. Then, the coding apparatus calculates a correlation between the transform coefficients in the high-band part and the changed transform coefficients in the low-band part. This configuration can guarantee a significant reduction in the amount of processing calculation over the entire frequency band (for all the plurality of subbands).

The coding apparatus does not equally determine, for all the subbands, transform coefficients targeted for the correlation calculation (amount-of-shift calculation), but can adaptively vary the transform coefficients in accordance with the degree of importance of each subband. More specifically, the coding apparatus can perform the amount-of-shift search with high accuracy on subbands whose subband energy is large and which are perceptually important (subbands whose degree of importance is high). On the other hand, the coding apparatus can perform the amount-of-shift search with low accuracy on subbands whose subband energy is small and which have small influence on perception (subbands whose degree of importance is low), whereby the amount of processing calculation can be significantly reduced. This can suppress significant quality degradation of a decoded signal.

In Embodiments 2 and 3, description has been given of an example configuration in which the degree-of-importance determining section determines the degree-of-importance information on the basis of the subband energy calculated by the subband energy calculation section. The present invention is not limited to this configuration and is similarly applicable to a configuration in which the degree of importance is determined on the basis of information other than the subband energy. In another example configuration, the degree of transform coefficient variation (for example, spectral flatness measure (SFM)) of each subband is calculated, and a higher degree of importance is set for a subband whose SFM value is larger. As a matter of course, the degree of importance may be determined on the basis of information other than the SFM value.

In Embodiments 2 and 3, the sparsification processing section fixedly determines a predetermined number of samples targeted for the correlation value calculation on the basis of the degree-of-importance information determined by the degree-of-importance determining section. The present invention is not limited to the configuration. For example, in the case where the subband energy values of high-ranked subbands are extremely close to each other, the degree-of-importance determining section may allow values with fractional values such as (1.0, 2.5, 2.5, 4.0) to be used for setting of the degree-of-importance information, instead of simply setting the degree-of-importance information using integer values of (1, 2, 3, 4). That is, the degree-of-importance information may be more finely set in accordance with a difference in subband energy among the subbands. In another example configuration, the sparsification processing section sets the predetermined number (the predetermined number of transform coefficients) such as (12, 8, 8, 6) on the basis of the degree-of-importance information. In this way, the sparsification processing section determines the predetermined number of transform coefficients using more flexible weighting (degree of importance) in accordance with subband energy distribution of the plurality of subbands, whereby the amount of processing calculation can be reduced still more efficiently than in the above-mentioned embodiments. The predetermined number of transform coefficients can be determined by preparing a plurality of pattern sets of the predetermined number of transform coefficients in advance. Alternatively, the predetermined number of transform coefficients can also be dynamically determined on the basis of the degree-of-importance information. Both the configurations presuppose that patterns of the predetermined number of transform coefficients are determined or the predetermined number of transform coefficients is dynamically determined such that the amount of processing calculation can be reduced by a given value or more for all the plurality of subbands.

Hereinabove, the embodiments of the present invention have been described.

The coding apparatus and the coding method according to the present invention are not limited to the above-mentioned embodiments, and can be variously changed and implemented.

It is assumed that the decoding apparatus in each of the above-mentioned embodiments performs processing using the coding information transmitted from the coding apparatus in each of the above-mentioned embodiments. The present invention is not limited to this case. Coding information does not have to be the coding information transmitted from the coding apparatus in each of the above-mentioned embodiments. As long as coding information contains necessary parameters and data, the processing can be performed.

The present invention is also applicable to cases where a signal processing program is recorded and written into a machine-readable recording medium such as memory, disk, tape, CD, and DVD, and is operated, and operations and effects similar to those in each of the above-mentioned embodiments can be obtained.

Also, although cases have been described with the above embodiments as examples where the present invention is configured by hardware, the present invention can also be implemented by software in concert with hardware.

Each function block employed in the description of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI as a result of the advancement of semiconductor technology or a derivative other technology, it is naturally also possible to carry out function block integration using this technology. Application of biotechnology is also possible.

The disclosure of Japanese Patent Application No. 2011-229616, filed on Oct. 19, 2011, including the specification, drawings, and abstract, is incorporated herein by reference in its entirety.

### INDUSTRIAL APPLICABILITY

The present invention can efficiently reduce the amount of calculation when a correlation operation is performed on an input signal, and is applicable to, for example, a packet communication system, a mobile communication system, and the like.

### REFERENCE SIGNS LIST

101, 501 Coding apparatus
102 Transmission path
103, 801 Decoding apparatus
201 Subframe energy calculation section
202, 704, 704a Degree-of-importance determining section
203 CELP coding section
301 Pre-processing section
302 Perceptual weighting section
303, 705, 705a Sparsification processing section
304 LPC analysis section
305 LPC quantization section
306, 403 Adaptive excitation codebook
307, 404 Quantization gain generation section
308, 405 Fixed excitation codebook
309, 310, 406, 407 Multiplying section
311, 313, 408, 905 Adding section
312 Perceptual weighting synthesis filter
314 Parameter determining section
315, 606 Multiplexing section
401, 901 Demultiplexing section
402 LPC decoding section
409 Synthesis filter
410 Post-processing section
601 Down-sampling section
602 Low-band signal coding section
603, 902 Low-band signal decoding section
604 Delaying section
605, 605a High-band signal coding section
701, 702, 1001 Frequency domain transform section
703, 703a Subband energy calculation section
706, 706a Correlation analysis section
903 Up-sampling section
904 High-band signal decoding section
1002 High-band spectrum generation section
1003 Time domain transform section

1. A coding apparatus comprising:
an acquisition section that acquires transform coefficients whose frequency band is divided between a low-band part and a high-band part;
a division section that divides one frequency band of the low-band part and the high-band part of the transform coefficients into a plurality of subbands;
a setting section that sets a degree of importance for each of the subbands;
a changing section that changes, to zero, amplitude values of a predetermined number of transform coefficients of a plurality of the transform coefficients included in each of the subbands, in accordance with the set degree of importance; and
a calculation section that calculates a correlation between the changed transform coefficients in the one frequency band and the transform coefficients in the other frequency band.

2. The coding apparatus according to claim 1, wherein the changing section sets a smaller number of transform coefficients whose amplitude value is changed to zero, for a subband whose degree of importance is higher.

3. The coding apparatus according to claim 1, wherein the setting section sets the degree of importance based on energy of each of the subbands.

4. The coding apparatus according to claim 3, wherein the setting section sets a higher degree of importance for a subband whose energy is larger.

5. The coding apparatus according to claim 1, wherein the changing section changes, to zero, the amplitude values of the predetermined number of transform coefficients whose amplitude value is smaller, among the plurality of transform coefficients in each of the subbands.

6. The coding apparatus according to claim 1, wherein the calculation section calculates the correlation for obtaining an amount of shift indicating the transform coefficients in the low-band part most similar to the transform coefficients in the high-band part.

7. The coding apparatus according to claim 1, wherein the setting section sets the degrees of importance such that the respective degrees of importance of the subbands are always different from one another.

8. A communication terminal apparatus comprising the coding apparatus according to claim 1.

9. A base station apparatus comprising the coding apparatus according to claim 1.

10. A coding method comprising:
acquiring transform coefficients whose frequency band is divided between a low-band part and a high-band part;
dividing one frequency band of the low-band part and the high-band part of the transform coefficients into a plurality of subbands;
setting a degree of importance for each of the subbands;
changing, to zero, amplitude values of a predetermined number of transform coefficients of a plurality of the transform coefficients included in each of the subbands, in accordance with the set degree of importance; and
calculating a correlation between the changed transform coefficients in the one frequency band and the transform coefficients in the other frequency band.
